(19) United States
(12) Patent Application Publication
(10) Pub. No.: US 2006/0132451 A1
(43) Pub. Date: Jun. 22, 2006

(54) Optically addressable matrix display

(75) Inventors: Bart Andre Salters, Eindhoven (NL); Gerrit Oversluizen, Eindhoven (NL); Thomas Caspar Kraan, Eindhoven (NL); Johannes Josephus Wilhelm Maria Rosink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/545,060

(22) PCT Filed: Jan. 29, 2004
(86) PCT No.: PCT/IB04/50065

§ 371 Date: Aug. 10, 2005

(30) Foreign Application Priority Data
Feb. 13, 2003 (EP) 03100319.7

(51) Int. Cl. G09G 5/00

(52) U.S. Cl. 345/173

(57) ABSTRACT

A matrix display comprises a matrix of optically addressable pixels (Pij). The pixels (Pij) comprise a light sensitive element (LSij) having a state depending on a brightness of control light (Lj) impinging on it. The pixels (Pij) further comprise a pixel light generating element (LGij) for generating pixel light (LMij) with a brightness depending on the state of the light sensitive element (LSij). The matrix display device comprises a sheet of transparent material (TS) positioned in front of the matrix of pixels (Pij), and a light source (LS) which couples source light into a side of the sheet of transparent material (TS). In use, the source light is substantially totally internally reflected in said sheet (TS). The control light (Lj) leaves the sheet (TS) at positions where the sheet (TS) is locally disturbed. This control light switches or changes the brightness of the pixels (Pij) at these positions, or provides touch position information.

The invention relates to an active matrix display, and a display apparatus comprising a matrix display.

U.S. Pat. No. 6,215,462 discloses a matrix display device with a plurality of rows of pixels. The rows of the matrix display are selected one by one. Each row is associated with a light waveguide which transports light generated by a first light emission element to the pixels of the row. A particular row is selected if the associated select light emission element produces light; all the other rows are not selected because their associated select light emission elements do not produce light.

Each pixel comprises a series arrangement of a light sensitive element and a pixel light emission element. A data voltage in accordance with the image data to be displayed is supplied to the series arrangement via column conductors. In the selected row of pixels, the light generated by the select light emission element associated with the selected row reaches the pixels of the selected row via the associated light waveguide. Consequently, the light sensitive elements of the pixels of the selected row have a low impedance, and the data voltage occurs substantially over the pixel light emission elements of the pixels of the selected row. Thus, the selected row of pixels will generate an amount of light in accordance with the image data presented on the column conductors which each are connected to a column of pixels. In the rows which are not selected, the select light emission elements do not produce light, and thus the impedance of the light sensitive elements of not selected pixels is high. For these pixels, the data voltage will substantially occur across the high impedance of the light sensitive elements, and consequently, the voltage across the pixel light emission elements will be below a threshold value such that the pixel light emission elements will not produce light.

This optically addressable matrix display is not sensitive to on screen input.

It is an object of the invention to provide a matrix display which is sensitive to on screen input.

A first aspect of the invention provides a matrix display as claimed in claim 1. A second aspect of the invention provides a display apparatus as claimed in claim 14. Advantageous embodiments are defined in the dependent claims.

The matrix display device in accordance with the first aspect of the invention comprises a matrix of optically addressable pixels. The pixels comprise a light sensitive element and a pixel light-generating element The light-generating element of a particular pixel produces a pixel light with a brightness that depends on the state of the light sensitive element of the particular pixel. The state of the light sensitive element depends on the amount of light impinging on it.

The matrix display further comprises a sheet of transparent material, which is positioned in front of the matrix of pixels, thus in-between the matrix of pixels and the viewer. A light source couples source light into one or more sides of the sheet. This source light will continuously reflect at the top plane (directed towards the viewer) and the bottom plane (directed towards the matrix of pixels) of the sheet and thus stay in the sheet. This well-known effect is called total internal reflection. If at the outside of the top plane of the sheet, at a particular position a disturbance is applied, the light will leave the bottom plane of the sheet at substantially this particular position. The disturbance may be a fingertip of the viewer, a stylus or any other object which has a refraction index which differs from the material of the sheet. Preferably, the object should not be transparent, to avoid the light to leave the plane via the transparent object. Ideally, a white surface which makes a good contact with the plane is used, however, a finger will do. Preferably, the sheet is of glass.

At the instant the disturbance is applied at the particular position, the light leaving the bottom plane of the sheet at this particular position impinges on the light sensitive element of the pixel or pixels present at this particular position. Consequently, the matrix display is sensitive to on-screen input

In an embodiment in accordance with the invention as claimed in claim 2, the matrix display comprise row electrodes and column electrodes. A particular one of the pixels is present between a particular row electrode and a particular column electrode. If light impinges on the light sensitive element of this particular pixel, the impedance variation of the light sensitive element can be detected between the particular row and column electrode. It is thus possible to determine the position of the disturbance in both the row and the column direction.

For example, in an embodiment in accordance with the invention the light sensitive element and the light generating element are arranged in series to receive a drive voltage via the row and column electrodes. The control light impinging on the light sensitive elements of the particular pixels associated with the position where the touch event occurs, will decrease the impedance of the associated light sensitive elements. Due to the lower impedance, the current flowing through the series arrangement will increase. It is thus possible to detect a position of the touch event by detecting in which column and row electrodes a higher current is flowing. The drive voltage and the current need actually not be high enough such that the pixel light generating elements generate light. But if the pixel light generating elements generate light this has the advantage that the user gets feedback on the touch position detected because the associated pixels will start emitting light. The pixels have to be reset regularly to stop producing light, or the pixel should have no memory effect or a limited memory effect only. A reset of the pixels is possible by temporarily lowering the drive voltage.

In an embodiment in accordance with the invention as claimed in claim 3, the drive voltage across the pixels is selected sufficiently high such that the light impinging on the light sensitive elements of the pixels causes the corresponding pixel light generating elements to produce light. Such a matrix display will indicate by producing light at the touch position at which position the screen is touched. This is interesting in applications like a drawing tablet on which one can draw a light emitting line. Such a drawing tablet can be used to make drawings or to write a text. Preferably the pixels have at least a temporarily memory effect such that the drawing or text can be stored for a particular time. It has to be noted that in this application it is not relevant to actually determine the touch position. It is thus not required to detect in which rows and columns a touch event occurs.

In an embodiment in accordance with the invention as claimed in claim 4, the pixels are present between the row electrodes and a common backplane electrode. The column electrodes are not required because it is not required to determine the position of the touch event. This provides a less complex construction of the matrix display.

In an embodiment in accordance with the invention as claimed in claim 5, the pixels are present between a common front plane electrode and a common backplane electrode. Both the row and the column electrodes are not required because it is not required to determine the position of the touch event. This provides a less complex construction of the matrix display.

In an embodiment in accordance with the invention as claimed in claim 6, the drive voltage is supplied across a series arrangement of the pixel light generating element and an impedance element of which the impedance depends on the state of the light sensitive element. If the drive voltage has a sufficiently high level and the impedance of the impedance element is low, the pixel light generating element will generate light because the drive voltage is substantially present across it. If the drive voltage has a sufficiently high level and the impedance of the impedance element is high, the pixel light generating element will not generate light because the select voltage is substantially present across the light sensitive element.

In an embodiment in accordance with the invention as claimed in claim 7, the light sensitive element itself is arranged in series with the pixel light-generating element. This has the advantage that a minimal amount of elements is used in a pixel, which provides a simple matrix display. It has to be noted that only simple two pole elements are required. Usually, if light impinges on it, the impedance of the light sensitive element is low with respect to the impedance of the pixel light-generating element, and if no light impinges on it, the impedance of the light sensitive element is high with respect to the impedance of the pixel light generating element.

In an embodiment in accordance with the invention as claimed in claim 8, the pixels comprise a capacitor to obtain a memory behavior of the pixels. The memory behavior of the pixels may be important if the optical state of the pixels should be kept for a longer time to indicate the touch input by generating light at the touch position.

In an embodiment in accordance with the invention as claimed in claim 9, the pixels are constructed such that in a pixel a portion of the pixel light generated by the pixel light generating element reaches the associated light sensitive element of the pixel. The light sensitive element is sensitive to the pixel light to obtain a feedback of the portion of the pixel light to the light sensitive element.

This optical feedback may be used to obtain a memory behavior of the pixel or to influence the memory behavior of the pixel. In the prior art U.S. Pat. No. 6,215,462, the pixels do not have a memory behavior. Because the pixels are selected row by row, the pixels of the rows will generate light during the relatively short select period of a row only.

This feedback may also be used to influence an intrinsic memory behavior of a pixel caused by a capacitance of the pixel. The portion of the light impinging on the light sensitive element is used to discharge the capacitance, as is defined in the embodiment of the invention of claim 12.

In an embodiment in accordance with the invention defined in claim 10, the light sensitive element itself is arranged in series with the pixel light-generating element. This has the advantage that the construction of the matrix display is simple.

In an embodiment in accordance with the invention defined in claim 11, a switching element has a main current path arranged in series with the pixel light generating element and a control electrode coupled to the light sensitive element. This has the advantage that the impedance of the light sensitive element is less important If light of the pixel light generating element impinges on the light sensitive element its impedance changes, which causes the switching element to get a low impedance. Again a memory behavior of the pixel is obtained.

In an embodiment in accordance with the invention defined in claim 12, a short light pulse suffices to charge the capacitor via the further switching element. The capacitor is discharged by the light sensitive element which receives a portion of the pixel light from the pixel light generating element.

In this manner, in response to the control light pulse, the pixel starts with a high brightness which gradually decreases. The control light pulse occurs at a position where the sheet is temporarily touched. The value of the capacitor determines the time during which the brightness decreases to zero. The brightness and/or duration of the data light pulse determine the peak brightness of the pixel. The pixels have thus a temporarily memory behavior, this might be interesting when the matrix display is used as a touch position detector which should be able to detect several touch events in a certain time frame, or when the drawing tablet should be self erasable. It is also possible to provide a user interface allowing the user to indicate when the pixels should be reset. Lowering the drive voltage below a predetermined level can perform the reset.

Further, it is an advantage that the brightness of the pixel is substantially independent on the quality of the pixel light-generating element if this is a (Poly) LED (light emitting diode). If the (poly) LED does not function well, it will take longer to discharge the capacitor, and thus, the net amount of light produced is substantially equal.

Thus, now the intrinsic memory behavior of the pixels is influenced by the feedback of the portion of the light generated by the pixel light-generating element which impinges on the light sensitive element.

These and other aspects of the invention are apparent from and will be elucidated with reference to the embodiments described hereinafter.

### IN THE DRAWINGS

FIG. 1 shows a schematic representation of a display apparatus in accordance with the invention,

FIG. 2 shows a schematic representation of a matrix display and a sheet of transparent material in accordance with an embodiment of the invention,

FIG. 3 shows an embodiment of a display cell in accordance with the invention,

FIG. 4 shows an embodiment of a display cell in accordance with the invention, and

FIG. 5 shows an embodiment of a display cell in accordance with the invention.

The same references in different Figs. refer to the same signals or to the same elements performing the same function.

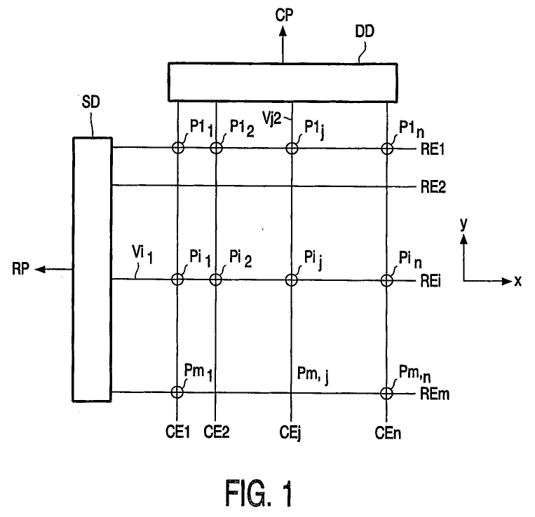

FIG. 1 shows a schematic representation of an embodiment of a matrix display apparatus with optically addressed display cells or pixels. The matrix display apparatus comprises a matrix of pixels Pij (P11 to Pmn) which are associated with intersections of column electrodes CEj (CE1 to CEn) and row electrodes REi (RE1 to REm). The index i indicates the row number, the index j indicates the column number of the matrix display. The row electrodes REi extend in the x-direction, the columns electrodes CEj extend in the y-direction. In a transposed matrix display, the x and y direction are interchanged.

A row driver SD supplies row voltages VRi to the row electrodes REi. The column driver DD supplies column voltages VCj to the column electrodes CEj. The drive voltage SVi which occurs between the row electrodes REi and the column electrodes CEj is present across the pixels Pij.

Optionally, the row driver SD may output a row detect signal RP which indicates at which rows a touch event is detected, and the column driver DD may output a column detect signal CP indication at which columns a touch event is detected.

The sheet of transparent material, which is located on top of the matrix of pixels Pij, is not shown. This sheet may be integrated together with the matrix of pixels Pij, or may be separately positioned in front of the substrate comprising the matrix of pixels Pij.

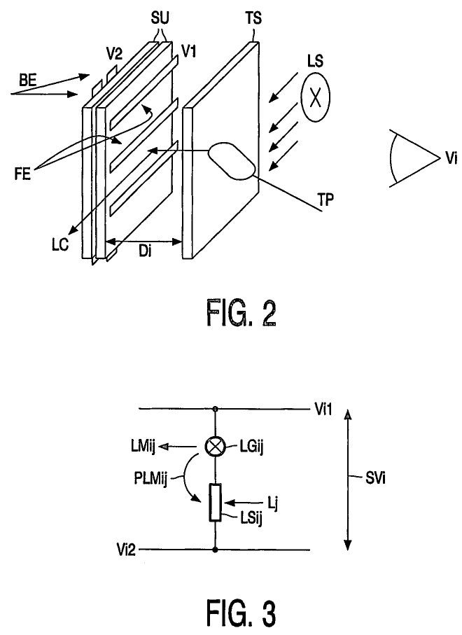

FIG. 2 shows a schematic representation of a matrix display and a sheet of transparent material in accordance with an embodiment of the invention. A light source LS directs light into a side of the transparent sheet TS. The light will be trapped in the sheet TS due to internal reflection in the sheet TS. The substrate SU comprises the pixels Pij (not shown), the front electrodes FE and the back electrodes BE. By way of example only, the front electrodes FE are the row electrodes REi of FIG. 1 and the back electrodes BE are the column electrodes CEj of FIG. 1. The touch position is indicated by TP. At this position TP, the light trapped in the sheet TS will be able to leave the sheet TS as the coupled out light LC. The light LC will impinge on the pixel or the pixels Pij present at the touch position TP.

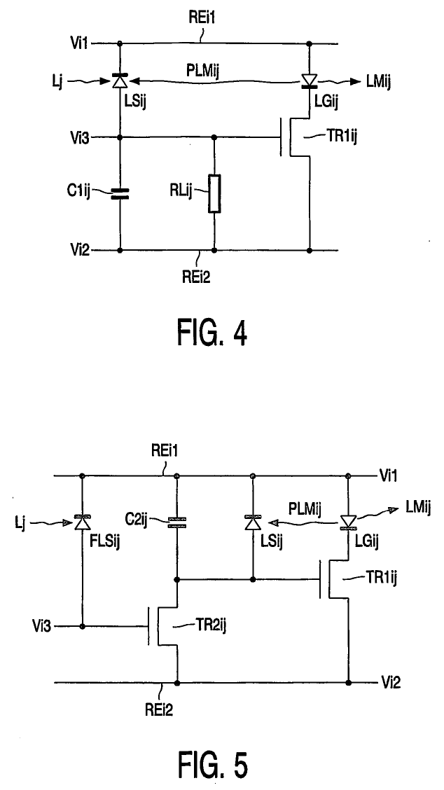

If the matrix display is used to determine the touch position TP, the drive voltage SVi may have a level which does allow the state of the light generating elements LGij (see FIGS. 3 to 5) to change dependent on whether the light LC impinges on the corresponding light sensitive elements LSij (see FIG. 3 or 4) or FLSij (see FIG. 5) or not. But this is not required. When the light LC impinges on the pixels Pij corresponding to the position where the touch event takes place, only the light sensitive elements LSij of these pixels will change state. Usually, the change of state is a change of the impedance of the light sensitive elements. This change of state can be detected between the corresponding row electrodes RE and column electrodes CE. Even if the pixel light generating elements PGij do not produce light. Consequently, the row driver SD is able to detect at which row position or positions the touch event occurs and to output a row detect signal RP indicating this position or these positions. In the same manner, the column driver DD is able to detect at which column position or positions the touch event occurs and to output a column detect signal CP indicating this position or these positions. The row detect signal RP and the column detect signal CP together determine the coordinates of the touch position TP.

If the matrix display is used as a drawing tablet, the drive voltage SVi must have a level which does allow the state of the light generating elements LGij to change dependent on whether the light LC impinges on the corresponding light sensitive elements LSij or FLSij or not. At the instant the light LC impinges on a pixel Pij, this pixel Pij starts emitting light. Consequently, the matrix display will produce light at the touch position(s). Because detecting the touch position no longer is required, both the front electrodes FE and the back electrodes BE may become a plate electrode connected to all the pixels Pij. However, the front plate FE has to be transparent to enable the light LC to reach the light sensitive elements LSij of the pixels Pij. It might be more convenient to structure the front electrodes as row or column electrodes instead of a plate electrode. It is also possible to structure the front electrodes FE and the back electrodes BE both in the row direction or both in the column direction.

FIG. 3 shows an embodiment of a display cell in accordance with the invention. The display cell or pixel Pij comprise a series arrangement of a pixel light generating element LGij and a light sensitive element LSij of which an impedance depends on an amount of received light Lj. The series arrangement of the pixel light generating element LGij and the light sensitive element LSij is arranged between the row electrode REi and the column electrode CEj to receive the pixel voltage SVi (see FIG. 1), or between the front electrodes FE and the back electrodes BE (see FIG. 2). The voltage on the row electrode REi is denoted by VRi, the voltage on the column electrode CEj is denoted by VCj, and the pixel voltage SVi is the difference of the voltages VRi and VCj.

If the same pixel voltage SVi is supplied to all the pixels Pij, the state of the pixel light generating elements LGij is determined by the intensity of the light LC. The level of the pixel voltage SVi is selected sufficiently high to allow the state of the pixel light generating elements LGij to be changed dependent on whether the intensity of the light LC is high or low.

By way of example, the pixels Pij may be constructed such that the pixel light generating elements LGij produces light when the impedance of the light sensitive elements LSij is low, and the pixel light generating elements LGij do substantially not produce light when the impedance of the light sensitive elements LSij is high. Thus, a high intensity of the light LC will cause the pixel light generating element LGij to produce light and a low intensity of the light LC will cause the pixel light generating element LGij to not produce light. The light LC will have a high intensity at the touch position(s) TP and a low intensity at non-touch positions.

Many constructions of the pixels Pij are possible, for example, it is also possible to use a pixel construction as shown in FIG. 4 wherein the light sensitive element LSij is used to switch a transistor TR1ij of which the main current path is arranged in series with the pixel light generating element LGij. Any other construction of the pixels Pij wherein an impedance value of an element arranged in series with the pixel light-generating element LGij depends on whether light is supplied to the pixel will operate in the same manner.

In an embodiment in accordance with the invention in which optical feedback is present, a portion of the pixel light PLMij produced by the pixel light generating element LGij will reach the light sensitive element LSij.

The operation of the pixel Pij with optical feedback is elucidated in the now following. The total amount of light falling onto the light sensitive element LSij is the combination of the portion of the pixel light PLMij generated by the pixel light generating element LGij and the light LC originating from the sheet TS.

Initially, the pixel Pij is in the off state, even if a considerable pixel voltage SVi is present across the series arrangement. The high impedance of the light sensitive element LSij causes the pixel voltage SVi to be substantially present over the light sensitive element LSij, and thus a substantially zero voltage is present across the pixel light generating element LGij.

If a particular pixel Pij should produce light due to the impinging light LC at the touch position TP, the impedance of the light sensitive element LSij will become low with respect to the impedance of the pixel light generating element LGij and the pixel voltage SVi will be substantially present across the pixel light generating element LGij. The pixel light generating element LGij will start to emit the pixel light LMij. Upon switching off the light LC (which usually occurs when no touch event occurs anymore at the particular touch position TP at which the pixel Pij is present), the pixel Pij remains in the on-state since the portion of the light PLMij generated by the pixel light generating element LGij is captured by the light sensitive element LSij which keeps it impedance low. The pixel Pij may be switched off by reducing the select voltage SVi below a threshold value. The pixel Pij thus has an in-built memory brought about by optical feedback to the light sensitive element LSij.

The pixel light generating elements LGij may, for example, comprise small lasers, LED's (light emitting diodes), OLED's (Organic LED's), PolyLED's, small incandescent lamps or fluorescent lamps, or light generating elements as used in plasma displays. The light sensitive elements may, for example, comprise LDR's (light dependent resistors), or LAS (light activated thyristors or other light activated electronic switches).

Such an optical addressed display is inexpensive and relatively easy to manufacture. The dimensions are easily scalable, only simple two terminal memory elements are required, and a high lumen efficacy is possible if used as a drawing tablet.

FIG. 4 shows another embodiment of a display cell in accordance with the invention. The pixel light generating element LGij is arranged in series with the main current path of a transistor TR1ij between the row electrode REi and the column electrode CEj. The voltage on the row electrode REi is denoted by VRi, the voltage on the column electrode CEj is denoted by VCj, the drive voltage SVi is the difference of the voltages VRi and VCj. The light sensitive element LSij is arranged between the control electrode of the transistor TR1ij and the row electrode REi. An optional capacitor C1ij is arranged between the control electrode of the transistor TR1ij and the column electrode CEj. An optional leakage resistor RLij is also arranged between the control electrode of the transistor TR1ij and the column electrode CEj.

If the control light LC impinges on the light sensitive element LSij, the transistor TR1ij becomes low-ohmic and the drive voltage SVi is substantially present across the pixel light generating element LGij which starts emitting pixel light LMij. A portion of the pixel light PLMij impinges on the light sensitive element LSij which thus will keep the pixel in the on-state even when the light LC is not anymore supplied. The pixel light generating element LGij will stop emitting light when the select voltage SVi drops below a particular value. The pixel light generating element LGij can also be switched off (or on) with the voltage Vi3.

The capacitor C1ij buffers the voltage on the control electrode of the transistor TR1ij and provides a memory behavior. The resistor RLij discharges the capacitor and thus determines the time constant of the memory.

FIG. 5 shows another embodiment of a display cell in accordance with the invention. The pixel light-generating element LGij is arranged in series with the main current path of a transistor TR1ij between the row electrode REi and the column electrode CEj. The voltage on the row electrode REi is denoted by VRi, the voltage on the column electrode CEj is denoted by VCj, the drive voltage SVi is the difference of the voltages VRi and VCj. The light sensitive element LSij is arranged between the control electrode of the transistor TR1ij and the row electrode REi. An optional capacitor C2ij is arranged between the control electrode of the transistor TR1ij and the row electrode REi. A main current path of a transistor TR2ij is arranged between the control electrode of the transistor TR1ij and the column electrode CEj. A light sensitive element FLSij is arranged between the control electrode of the transistor TR2ij and the row electrode REi.

If a short light pulse impinges on the light sensitive element FLSij, the transistor TR2ij becomes low-ohmic and the capacitor C2ij is charged to the drive voltage VSi. The transistor TR1ij starts conducting and the pixel light generating element LGij starts emitting pixel light LMij. The charge on the capacitor C2ij will keep the transistor TR1ij conductive. A portion of the pixel light PLMij impinges on the light sensitive element LSij which will discharge the capacitor C2ij. The impedance of the transistor TR1ij will gradually increase. In this manner, in response to the light pulse which occurs when the a touch event takes place at the position of the pixel Pij, the pixel Pij starts with a high brightness which gradually decreases. The value of the capacitor C2ij determines the time during which the brightness decreases to zero. The brightness and/or duration of the light pulse determine the peak brightness of the pixel Pij. This has the advantage that the matrix display has a self-erasing effect. The touch position TP of the touch events can be determined within a predetermined time frame, or the information displayed by the drawing tablet is kept during a predetermined time only, wherein the brightness of the display indicates how long ago the touch input at a particular position occurred.

Further, it is an advantage that the brightness of the pixel Pij is substantially independent on the quality of the pixel light generating element if this is a (Poly) LED (light emitting diode). If the (poly) LED does not function well, it well take longer to discharge the capacitor C2ij, and thus, the net amount of light produced is substantially equal.

It possible to switch off the pixel Pij with the voltage Vi3 at the control electrode of the transistor TR2ij.

It should be noted that the above-mentioned embodiments illustrate rather than limit the invention, and that those skilled in the art will be able to design many alternative embodiments without departing from the scope of the appended claims.

For example, the transistors which are shown to be MOSFETS, may also be bipolar transistors. All the transistors may be of the opposite conductivity type, the circuits have to be adapted in a manner known to the skilled person.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A matrix display with a matrix of optically addressable pixels (Pij), the pixels (Pij) comprising a light sensitive element (LSij) having a state depending on a brightness of control light (Lj) impinging on it, and a pixel light generating element (LGij) for generating pixel light (LMij) with a brightness depending on the state of the light sensitive element (LSij), the matrix display device comprising:
a sheet of transparent material (TS) positioned in front of the matrix of optically addressable pixels (Pij), and
a light source (LS) for coupling source light into a side of the sheet of transparent material (TS), wherein in use, the source light being substantially totally internally reflected in said sheet (TS) and the control light (Lj) leaving said sheet (TS) where locally disturbed.

2. A matrix display as claimed in claim 1, wherein the matrix display further comprises row electrodes (REi) extending in a row direction (x) of the matrix display and column electrodes (CEj) extending in a column direction (y) of the matrix display, the pixels (Pij) being associated with interstices of the row electrodes (REi) and the column electrodes (CEj) and being sandwiched in-between the row drive electrodes (REi) and the column electrodes (CEj).

3. A matrix display as claimed in claim 1, wherein the matrix display further comprises drive electrodes (REi, CEj) and a pixel driver (SD, DD) for supplying a drive voltage (SVi) via the drive electrodes (REi, CEj) to the pixels (Pij), the drive voltage (SVi) being selected for allowing the brightness of the light generating element (Lgij) to change depending on the brightness of the control light (Lj).

4. A matrix display as claimed in claim 3, wherein the drive electrodes (REi, CEj) comprise row drive electrodes (REi) extending in a row direction (x) of the matrix display and a backplane electrode, the pixels (Pij) being sandwiched in between the row drive electrodes (REj) and the back plane electrode.

5. A matrix display as claimed in claim 3, wherein the drive electrodes (REi, CEj) comprise a back plane electrode and a front plane electrode, the pixels (Pij) being sandwiched in between the front plane electrode and the back plane electrode.

6. A matrix display as claimed in claim 1, wherein the pixel light generating element (LGij) and an impedance element (LSij; TR1ij) are arranged in series, an impedance of the impedance element (LSij; TR1ij) being dependent on the state of the light sensitive element (LSij), and wherein the matrix display further comprises a pixel driver (SD, DD) for supplying a drive voltage (SVi) to the series arrangement of the impedance element (LSij; TR1ij) and the pixel light generating element (LGij).

7. A matrix display as claimed in claim 6, wherein the impedance element (LSij; TR1ij) comprises the pixel light generating element (LGij) of the pixel (Pij).

8. A matrix display as claimed in claim 1, wherein the pixels (Pij) comprise a capacitance (C2ij) to obtain a memory behavior.

9. A matrix display as claimed in claim 1, wherein the light sensitive element (LSij) and the pixel light generating element (LGij) are positioned with respect to each other to enable a portion of the pixel light (PLMij) generated by the pixel light generating element (LGij) to reach the light sensitive element (LSij) to obtain a feedback of the portion of the pixel light (PLMij) from the pixel light generating element (LGij) to the light sensitive element (LSij).

10. A matrix display as claimed in claim 9, wherein the light sensitive element (LSij) and the pixel light generating element (LGij) of the pixel (Pij) are arranged in series, and wherein the portion of the pixel light (PLMij) reaching the light sensitive element (LSij) is sufficient for keeping an impedance of the light sensitive element (LSij) relatively low with respect to an impedance of the pixel light generating element (LGij).

11. A matrix display as claimed in claim 9, wherein the pixels (Pij) further comprise a switching element (TR1ij) having a main current path arranged in series with the pixel light generating element (LGij), said series arrangement being coupled to the pixel driver (SD, DD) for receiving the associated one of the select voltages (SVi), and having a control electrode coupled to the light sensitive element (LSij), and wherein the portion of the pixel light (PLMij) reaching the light sensitive element (LSij) is sufficient for obtaining an impedance of the switching element (TR1ij) being relatively low with respect to an impedance of the pixel light generating element (LGij).

12. A matrix display as claimed in claim 11, wherein the pixels (Pij) further comprise:
a capacitor (C2ij) coupled to the control electrode of the first mentioned switching element (TR1ij),
a further light sensitive element (FLSij) for receiving the data light (Lj), and
a further switching element (TR2ij) having a control electrode coupled to the further light sensitive element (FLSij) and a main current path coupled to the control electrode of the first mentioned switching element (TR1ij).

13. A matrix display device as claimed in claim 1, wherein the light sensitive element (LSij) is a light-dependent resistor or a light-activated switch.

14. A display apparatus comprising a matrix display as claimed in claim 1.
